(19) United States
(12) Patent Application Publication
(10) Pub. No.: US 2016/0089995 A1
(43) Pub. Date: Mar. 31, 2016

(54) CHARGING STAND

(71) Applicant: CHUO HATSUJO KABUSHIKI KAISHA, Nagoya-shi (JP)

(72) Inventor: Akehito Sugiura, Nagoya-shi (JP)

(21) Appl. No.: 14/849,972

(22) Filed: Sep. 10, 2015

(30) Foreign Application Priority Data
Sep. 26, 2014 (JP) 2014-196198

(51) Int. Cl. B60L 11/18

(52) U.S. Cl. CPC B60L 11/1818; B60L 11/1824

(57) ABSTRACT

A charging stand includes a charging cable detachably attachable to an electrically-driven vehicle; a winding mechanism configured to wind the charging cable and having a movable portion that operates in accordance with a movement of the charging cable; a housing configured to house the winding mechanism; and a speed control mechanism configured to operate when the charging cable is wound by the winding mechanism and to control an operation speed of the movable portion so as not to exceed a preset speed.

### CROSS-REFERENCE TO RELATED APPLICATIONS

This application claims the benefit of Japanese Patent Application No. 2014-196198 filed Sep. 26, 2014 in the Japan Patent Office, the entire disclosure of which is incorporated herein by reference.

### BACKGROUND

The present disclosure relates to a charging stand that houses a charging cable for an electrically-driven vehicle. The electrically-driven vehicle means a vehicle having an electric motor for traveling. The electrically-driven vehicle includes, for example, an electric vehicle having only an electric motor as a driving source, a plug-in hybrid vehicle having an electric motor and an internal combustion engine as driving sources, and the like.

For example, in a charging stand described in Japanese Unexamined Patent Application Publication No. 2014-033576, a winding mechanism for winding a charging cable is housed in a housing. Once the winding mechanism starts winding of the charging cable, a movable pulley portion continues to pull the charging cable into the housing until the movable pulley portion hits a stopper or a bottom of the housing.

### SUMMARY

In the aforementioned invention, a movable member, such as the movable pulley portion, hits the stopper, or the like; accordingly, the charging cable is likely to oscillate greatly due to an impact at the time of hitting. If the charging cable vibrates greatly, rubbing of the charging cable against itself and rubbing of the charging cable against the housing might occur and cause early damage to the charging cable.

A charging stand in one aspect of the present disclosure comprises a charging cable detachably attachable to an electrically-driven vehicle, a winding mechanism configured to wind the charging cable and comprising a movable portion that operates in accordance with a movement of the charging cable, a housing configured to house the winding mechanism, and a speed control mechanism configured to operate when the charging cable is wound by the winding mechanism and to control an operation speed of the movable portion so as not to exceed a preset speed.

According to the present disclosure, it is possible to control the operation speed of the movable portion so as not to be excessively high, and thus it is possible to accordingly control the operation speed of the movable portion so as not to be high at the time of hitting. Consequently, an impact at the time of hitting can be reduced, and therefore large vibration of the charging cable can be inhibited.

Thus, it is possible to reduce rubbing of the charging cable against itself and rubbing of the charging cable against the housing; accordingly, it is possible to reduce early damage to the charging cable.

### BRIEF DESCRIPTION OF THE DRAWINGS

Hereinafter, preferred embodiments of the present disclosure will be described with reference to the accompanying drawings, in which:

FIG. 1 is an overall view showing a configuration of a charging stand according to a first embodiment;

FIG. 2 is a right side elevation view of FIG. 1;

FIG. 3A and FIG. 3B are explanatory views of an operation of a cable retention mechanism;

FIG. 4 is an overall view showing a configuration of a charging stand according to a second embodiment;

FIG. 5A and FIG. 5B are explanatory views of an operation of a centrifugal brake mechanism;

FIG. 6 is an explanatory view of a speed control mechanism according to a third embodiment;

FIG. 7 is an explanatory view of the speed control mechanism according to the third embodiment;

FIG. 8 is an explanatory view of the speed control mechanism according to the third embodiment; and

FIG. 9 is an explanatory view of the speed control mechanism according to the third embodiment.

### DETAILED DESCRIPTION OF THE PREFERRED EMBODIMENTS

Embodiments described hereinafter are illustrative only. Matters, including the invention specifying matters, recited in the claims are not limited to specific means, structures, or the like shown in the embodiments below.

Each of the present embodiments is an example of a charging stand that houses a charging cable for a plug-in hybrid vehicle (hereinafter referred to as an “electrically-driven vehicle”). Arrows indicating directions, or the like in the figures are provided for better understanding of the relationships among the figures, and are not intended to limit the scope of the present disclosure.

At least each member or portion described with an assigned reference numeral is provided in a number of at least one, except when a specific reference, such as “a plurality of” and “two or more”, is made.

### First Embodiment

1. Overview of Charging Stand

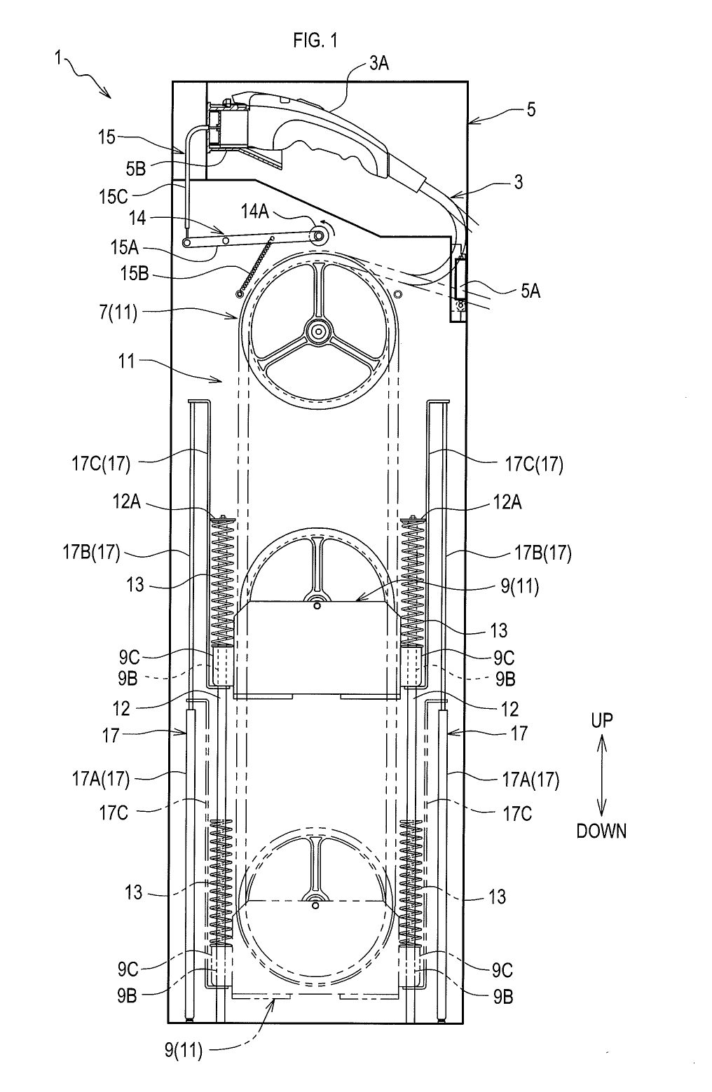

As shown in FIG. 1, a charging stand 1 comprises a housing 5, a winding mechanism 11, and other components. A charging cable 3 is a cable having flexibility and configured to electrically connect a power source for charging (not shown) and an electrically-driven vehicle.

At one longitudinal end of the charging cable 3 is provided a plug portion 3A to connect the charging cable 3 to an electrically-driven vehicle. The plug portion 3A is a connection that is detachably attachable to an electrically-driven vehicle. The other longitudinal end of the charging cable 3 is connected to the power source.

The housing 5 is a storage container to store the charging cable 3. The housing 5 is formed, for example, by shaping a metal sheet of SPCC (cold rolled steel) or the like into a cylindrical shape (a square cylindrical shape in the present embodiment). The housing 5 is installed such that a longitudinal direction of the housing 5 is the same as the vertical direction.

The housing 5 is provided with a port 5A through which the charging cable 3 passes. The port 5A is located at a vertically upper part of the housing 5 and is opened in a horizontal direction. Vertically above the port 5A in the housing 5A is provided a plug placement portion 5B.

The plug placement portion 5B is a cylindrical portion into which a leading end of the plug portion 3A is inserted. A winding mechanism 11 to wind the charging cable 3 is provided vertically below the plug placement portion 5B in the housing 5.

2. Configuration of Winding Mechanism

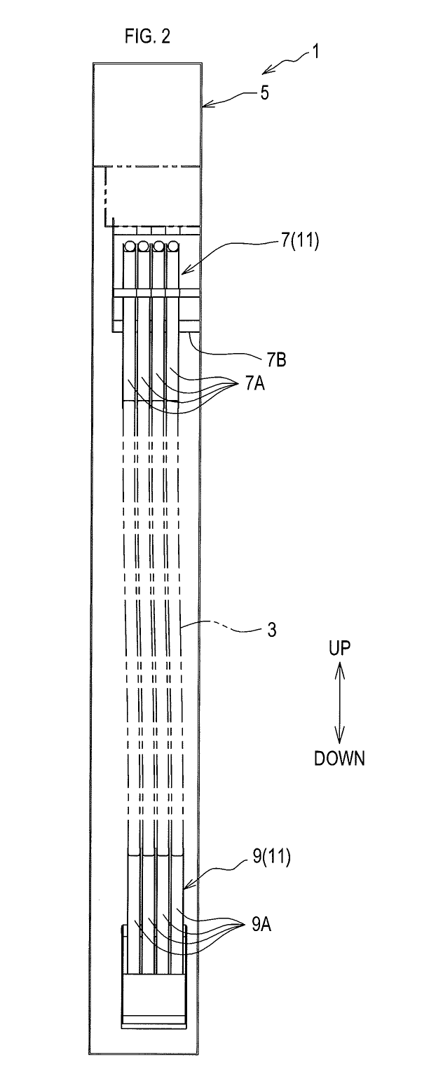

The winding mechanism 11 comprises a stationary pulley portion 7, a movable pulley portion 9, and other components. As shown in FIG. 2, the stationary pulley portion 7 and the movable pulley portion 9 are arranged in the housing 5. The stationary pulley portion 7 comprises at least one pulley 7A, whereas the movable pulley portion 9 comprises at least one pulley 9A. The at least one pulley 7A and the at least one pulley 9A each have a disk-like shape, and the charging cable 3 is wound around the at least one pulley 7A and the at least one pulley 9A.

Specifically, the stationary pulley portion 7 comprises a plurality of (four in the present embodiment) pulleys 7A. Each of the plurality of pulleys 7A is supported by a shaft 7B that is fixed to the housing 5 so as to be rotatable with respect to the shaft 7B. Consequently, the plurality of pulleys 7A are rotatable in accordance with a movement of the charging cable 3, without moving with respect to the housing 5.

The movable pulley portion 9 comprises a plurality of (four in the present embodiment) pulleys 9A. The plurality of pulleys 9A can collectively move in a receding manner or in an approaching manner with respect to the stationary pulley portion 7. Also, the plurality of pulleys 9A are each rotatable. The charging cable 3 is wound around the stationary pulley portion 7 and the movable pulley portion 9 in a state where the movable pulley portion 9 is located below the stationary pulley portion 7.

As shown in FIG. 1, the charging cable 3 extends vertically downward from its fixed end that is fixed to the stationary pulley portion 7; then, its extending direction is changed upward by the movable pulley portion 9, and the charging cable 3 returns to the stationary pulley portion 7. Accordingly, when the charging cable 3 is pulled out of the housing 5, the movable pulley portion 9 is shifted upward in proportion to a pulled out length of the charging cable 3.

A force to shift the movable pulley portion 9 downward is always exerted on the movable pulley portion 9 due to gravity acting on the movable pulley portion 9. When the movable pulley portion 9 is shifted downward, the charging cable 3 is pulled into the housing 5 in proportion to an amount of the shift. That is to say, the movable pulley portion 9 functions as a movable portion that operates in accordance with the movement (pulling in and pulling out) of the charging cable 3.

A pair of (two) guide members 12 guide the movable pulley portion 9. Each of the guide members 12 is provided on horizontally either side of the movable pulley portion 9. In other words, the two guide members 12 are provided on respective sides, with the movable pulley portion 9 located therebetween, in a horizontal direction perpendicular to rotation axes of the plurality of pulleys 9A.

Each of the two guide members 12 is a rod-like member extending vertically. A guided portion 9C corresponding to each of the guide members 12 is provided to the movable pulley portion 9; that is, there are total two guided portions 9C. Each of the two guided portions 9C has a guide hole 9B. Each of the guide members 12 passes through the corresponding guide hole 9B.

An inner circumferential surface of each of the two guide holes 9B slidingly contacts with the corresponding one of the two guide members 12, with the result that the movable pulley portion 9 is guided by the two guide members 12. At an upper end of each of the two guide members 12A is provided an umbrella-shaped stopper portion 12A.

A coil spring 13 is arranged between the stopper portion 12A and the corresponding guided portion 9C. Specifically, the coil spring 13 is arranged between one of the two stopper portions 12A and the corresponding one of the two guided portions 9C. When the movable pulley portion 9 is shifted, the two coil springs 13 are shifted along with the movable pulley portion 9. A natural length of the coil spring 13 is set such that, when a distance between the movable pulley portion 9 and the stationary pulley portion 7 reaches a previously set distance (hereinafter referred to as a “set distance”), an upper end of the coil spring 13 contacts the corresponding stopper portion 12A. This setting applies to both of the two coil springs 13.

When the distance between the movable pulley portion 9 and the stationary pulley portion 7 becomes shorter than the set distance, the two coil springs 13 are compressed and deformed. Accordingly, in a state where the movable pulley portion 9 becomes closest to the stationary pulley portion 7, that is, in a state where the charging cable 3 is pulled out most, the two coil springs 13 exert forces on the movable pulley portion 9 so as to shift the movable pulley portion 9 downward.

At a lower end of each of the two guide members 12 is provided at least one stopper (not shown) to restrict shifting of the movable pulley portion 9 downward. When the movable pulley portion 9 is shifted downward and hits the at least one stopper, further downward shifting of the movable pulley portion 9 is restricted.

3. Speed Control Mechanism

A speed control mechanism 17 is a mechanism to control an operation speed of a movable portion, such as the movable pulley portion 9, so as not to exceed a preset speed; the speed control mechanism 17 at least operates when the charging cable 3 is wound by the winding mechanism 11. Although a pair of (two) speed control mechanisms 17 are provided, a description will be given here of only one of the speed control mechanisms 17.

Specifically, the speed control mechanism 17 is a viscous damper mechanism that comprises a tubular cylinder 17A, a rod 17B that slidingly moves along the cylinder 17A, and a coupling member 17C that couples the rod 17B with the movable pulley portion 9.

A viscous fluid, such as oil, is encapsulated in the cylinder 17A. At a cylinder 17A side end of the rod 17B is provided a piston (not shown) that divides an interior space of the cylinder 17A into two subspaces and also slidingly contacts an inner wall of the cylinder 17A.

The piston is provided with at least two communication paths (not shown) to allow communication between the two subspaces. In one communication path having a smaller pressure loss (flow resistance) of the at least two communication paths is arranged a one-way valve (not shown) that allows the viscous fluid to flow therethrough in only one direction.

The one-way valve opens the one communication path to allow the viscous fluid to flow therethrough when the rod 17B comes out from the cylinder 17A, whereas the one-way valve closes the one communication path to inhibit the viscous fluid from flowing therethrough when the rod 17B enters the cylinder 17A.

Consequently, the pressure loss generated when the rod 17B comes out from the cylinder 17A is smaller, whereas the pressure loss generated when the rod 17B enters the cylinder 17A is larger. That is to say, the speed control mechanism 17 functions as a damper to reduce increase in shifting speed of the movable pulley portion 9 when the charging cable 3 is wound.

4. Cable Retention Mechanism

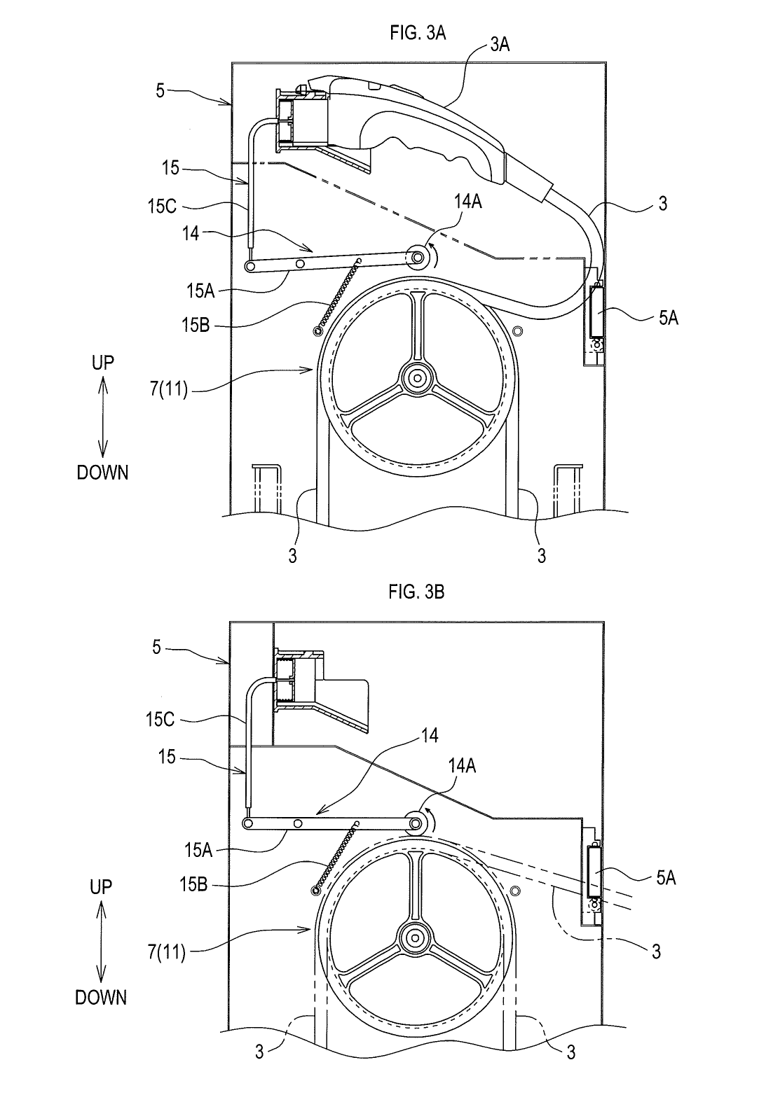

A cable retention mechanism 14 at least serves a function to prevent the charging cable 3 from being pulled into the housing 5. Specifically, as shown in FIG. 3A and FIG. 3B, the cable retention mechanism 14 comprises an abutment member 14A and an attachment/detachment interlocking mechanism 15.

The abutment member 14A is configured to be capable of contacting the charging cable 3 and separating from the charging cable 3. For example, the abutment member 14A can contact a part of the charging cable 3, the part contacting the stationary pulley portion 7 (see FIG. 3B). When contacting the charging cable 3, the abutment member 14A presses the charging cable 3 against the stationary pulley portion 7 (see FIG. 3B).

The abutment member 14A comprises a rotation body (a roller) that is rotatable only in a direction corresponding to pulling out of the charging cable 3. The roller comprised in the abutment member 14A (in other words, the roller forming the abutment member 14A) is rotatably supported via a one-way clutch (not shown) that allows rotation only in one direction. Accordingly, while the abutment member 14A contacts the charging cable 3, the charging cable 3 is prevented from being pulling into the housing 5, whereas the charging cable 3 is allowed to be pulled out from the housing 5.

The attachment/detachment interlocking mechanism 15 is a mechanism that causes the abutment member 14A to separate from the charging cable 3 or to contact the charging cable 3 depending on whether or not the plug portion 3A is placed on the plug placement portion 5B. The attachment/detachment interlocking mechanism 15 comprises an arm member 15A, a spring 15B, an interlocking member 15C, and other components.

The arm member 15A is an arm-shaped member that is swingably assembled to the housing 5. The abutment member 14A is assembled to an end of the arm member 15A. The spring 15B is an elastic member that applies elastic force to the arm member 15A. The abutment member 14A is pressed against the charging cable 3 by the elastic force of the spring 15B.

The interlocking member 15C is shifted by being mechanically interlocked with attachment and detachment of the plug portion 3A to and from the plug placement portion 5B, and thereby transmits the shift to the arm member 15A. The interlocking member 15C is configured with a push-pull wire that is capable of transmitting pushing force and pulling force.

5. Features of Charging Stand of Present Embodiment

According to the present embodiment, it is possible to control the operation speed of the movable pulley portion 9 so as not to be excessively high; accordingly, it is possible to reduce increase in the operation speed of the movable pulley portion 9 when the movable pulley portion 9 hits the at least one stopper.

It is, therefore, possible to reduce an impact at the time of hitting, and to thereby inhibit a large vibration of the charging cable 3. Thus, it is possible to inhibit, for example, “rubbing of the charging cable 3 against itself”, “rubbing of the charging cable 3 against the housing 5”, and “rubbing of the charging cable 3 against multiple pulleys 7A, 9A, and the like”, thereby inhibiting early damage to the charging cable 3.

### Second Embodiment

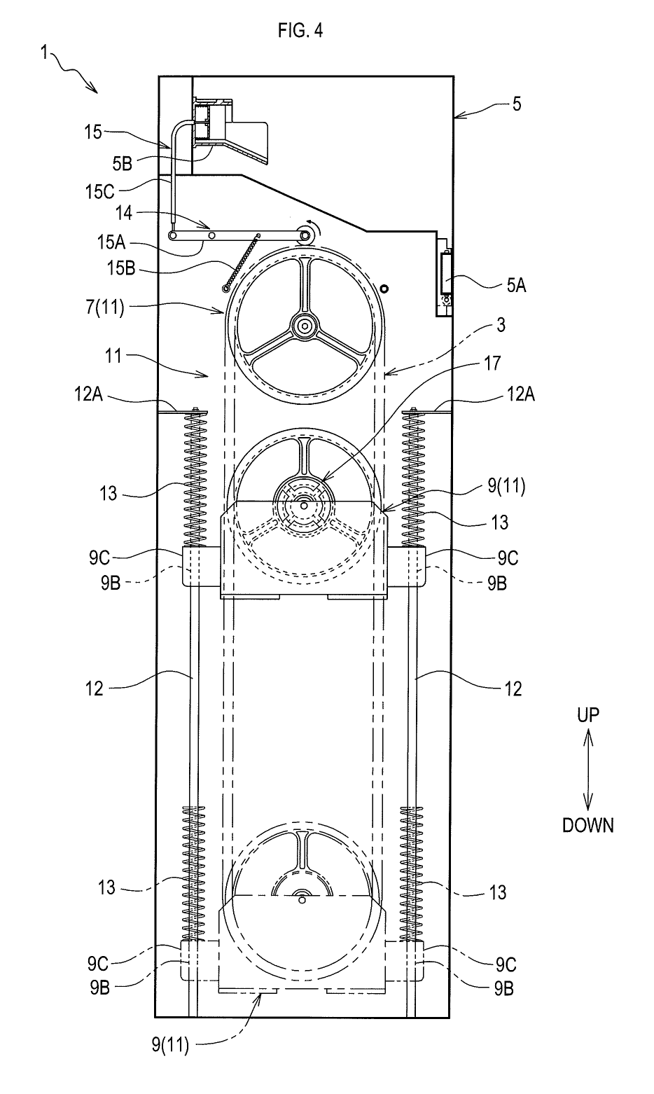

In a second embodiment, the speed control mechanism 17 comprises a centrifugal brake mechanism. Specifically, as shown in FIG. 4, a centrifugal brake mechanism to form the speed control mechanism 17 is internally installed in the movable pulley portion 9.

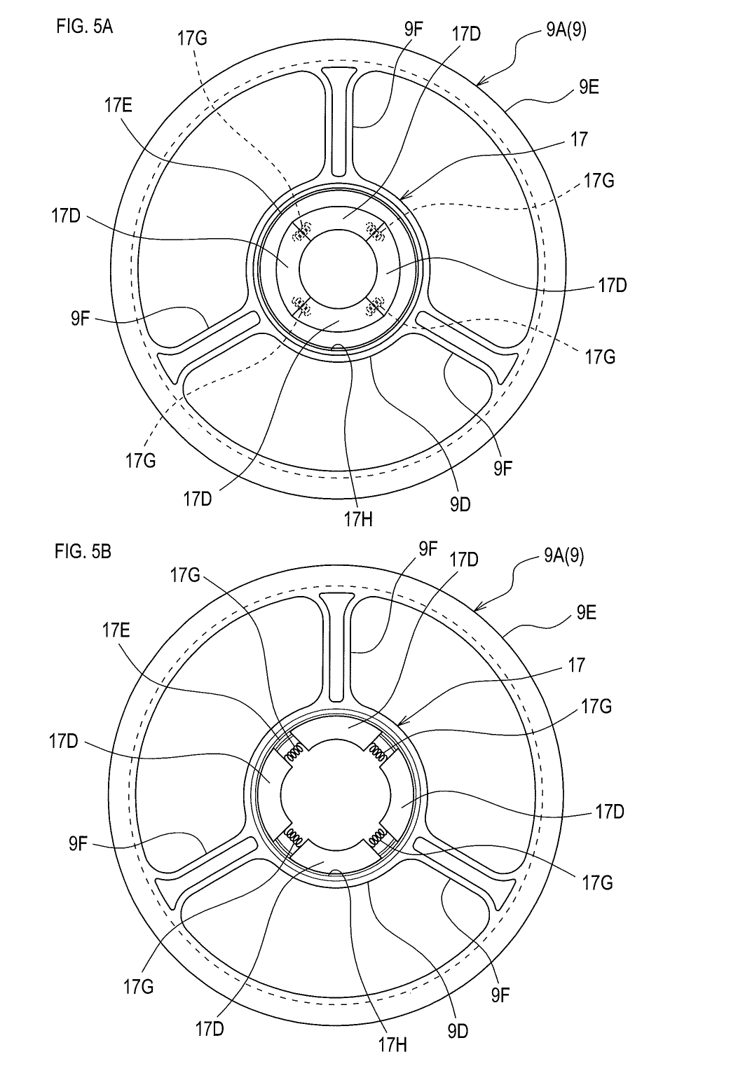

As shown in FIG. 5A, the speed control mechanism 17, that is, the centrifugal brake mechanism comprises a plurality of (four in the second embodiment) brake shoes 17D, a brake drum 17E, and other components. As shown in FIG. 5B, the plurality of brake shoes 17D are arranged in a rotation center section (hereinafter referred to as a “hub”) 9D of the pulley 9A.

The hub 9D is a cylindrical part and is provided, on an outer circumferential surface thereof, with at least one (three in the second embodiment) spoke 9F that extends radially. The three spokes 9F couple an outer wheel portion 9E, around which the charging cable 3 is wound, with the hub 9D.

The plurality of brake shoes 17D are shiftable in a radial direction in accordance with the operation of the movable pulley portion 9, specifically, with the upward/downward shifting of the movable pulley portion 9, while rotating along with the pulley 9A. The brake shoes 17D neighboring each other are coupled by at least one (four in the second embodiment) elastic member 17G. The at least one elastic member 17G may be a coil spring.

The brake drum 17E is provided at an inner circumference of the hub 9D. The brake drum 17E has, at an inner circumference side thereof, an inner circumferential surface 17H that is slidingly contactable with the plurality of brake shoes 17D. A friction force generated at a contact surface between the inner circumferential surface 17H and the plurality of brake shoes 17D functions as a damping force to reduce increase in the operation speed of the movable pulley portion 9.

When the operation speed of the movable pulley portion 9 is increased, a rotation speed of the pulley 9A, and thus of the hub 9D, is increased in a linked manner. In this case, a centrifugal force exerted on each of the brake shoes 17D becomes larger; accordingly, each the brake shoes 17D is shifted radially outward, and the at least one elastic member 17G is elastically deformed.

When the plurality of brake shoes 17D contact the inner circumferential surface 17H of the brake drum 17E (see FIG. 5B), a damping force is generated, inhibiting increase in the rotation speed of the pulley 9A. Thus, the operation speed of the movable portion, including the movable pulley portion 9, is controlled so as not to exceed a preset speed.

As the operation speed of the movable pulley portion 9 is lowered, a rotation speed of the hub 9D is lowered in a linked manner. Then, the centrifugal force exerted on each the brake shoes 17D is reduced; thus, each of the brake shoes 17D is shifted radially inward by the elastic force of the at least one elastic member 17G, and separates from the inner circumferential surface 17H (see FIG. 5A).

As described above, it is possible also in the second embodiment to control the operation speed of the movable pulley portion 9 so as not to be excessively high; therefore, it is possible to reduce the impact applied when the movable pulley portion 9 hits the at least one stopper. Thus, large vibration of the charging cable 3 can be inhibited.

Although the centrifugal brake mechanism (the speed control mechanism 17) is provided to one of the plurality of pulleys 9A in the second embodiment, the second embodiment is not limited to this configuration. It may be possible to employ a configuration in which the centrifugal brake mechanism is provided to each of the plurality of pulleys 9A, a configuration in which the centrifugal brake mechanism is provided to a rotating body that is separate from the plurality of pulleys 9A, a configuration in which the centrifugal brake mechanism is provided to the stationary pulley portion 7, or other configurations.

### Third Embodiment

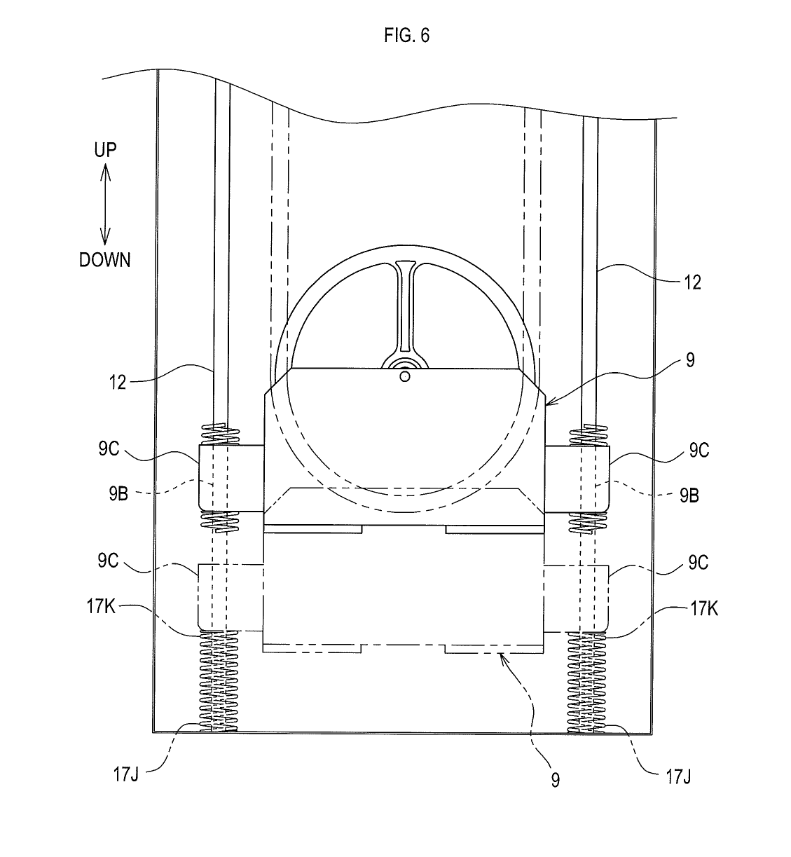

In a third embodiment, the speed control mechanism 17 comprises at least one elastic body 17J as the at least one stopper, as shown in FIG. 6 to FIG. 9. The at least one elastic body 17J is made of an elastic material that is elastically deformable.

The at least one elastic body 17J is arranged on a bottom portion in the housing 5, and is elastically deformable at least in an operation direction of the movable pulley portion 9 (in a vertical direction). At a movable pulley portion 9—side end of the at least one elastic body 17J is provided an abutment portion 17K that contacts the movable pulley portion 9. Accordingly, the abutment portion 17K is at least one in number.

When the movable pulley portion 9 is shifted toward the at least one elastic body 17J, and contacts the at least one abutment portion 17K, the at least one elastic body 17J exerts on the movable pulley portion 9 an elastic force in a direction to inhibit the shifting of movable pulley portion 9 through the at least one abutment portion 17K.

As described above, it is possible also in the third embodiment to control the operation speed of the movable pulley portion 9 so as not to be excessively high; therefore, it is possible to reduce the impact applied when the movable pulley portion 9 hits at least one stopper. Thus, large vibration of the charging cable 3 can be inhibited.

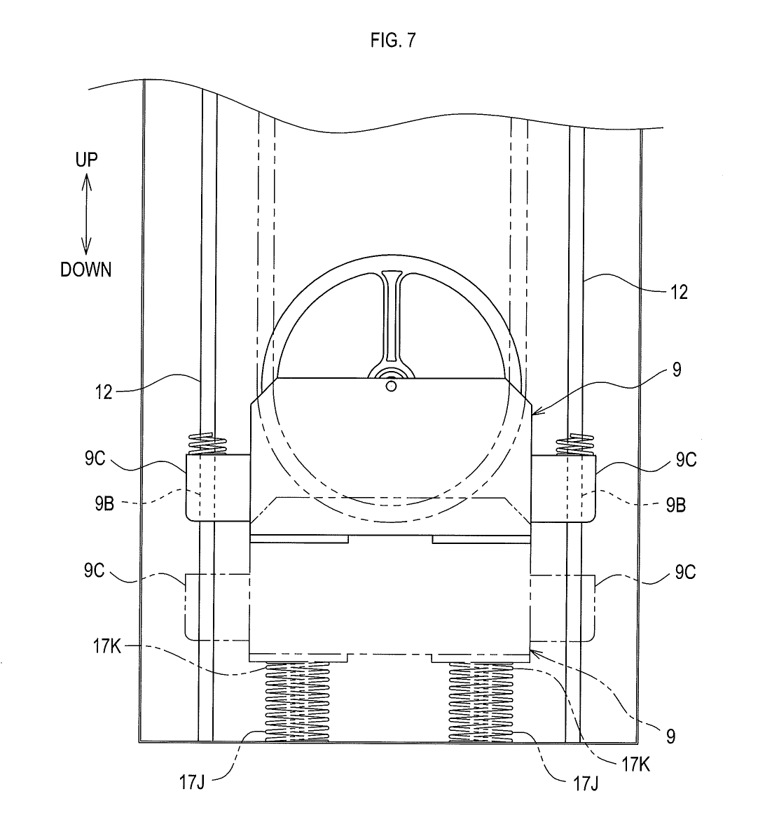

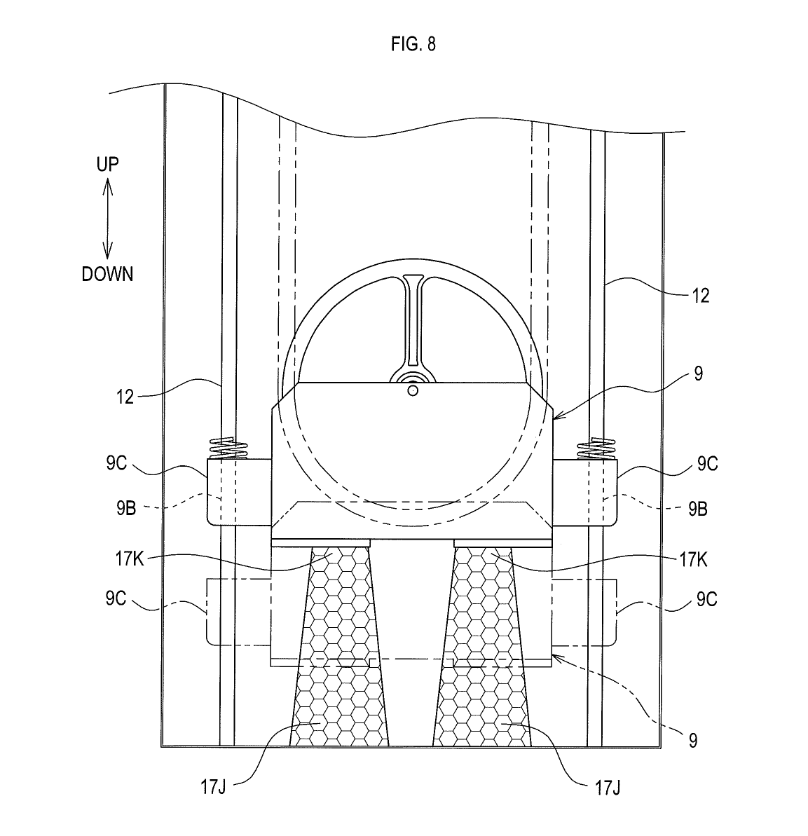

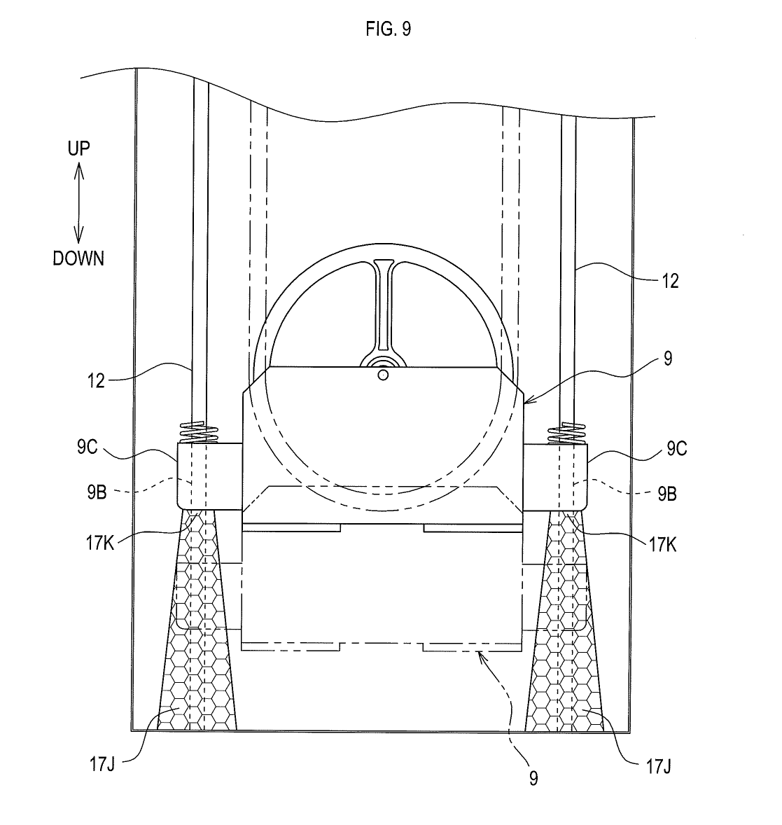

FIG. 6 and FIG. 7 show examples in each of which the elastic body 17J is made of a coil spring. FIG. 8 and FIG. 9 show examples in each of which the at least one elastic body 17J is made of rubber. FIG. 6 and FIG. 9 each show an example in which each of the at least one abutment portion 17K contacts the corresponding one of the plurality of guided portions 9C of the movable pulley portion 9. FIG. 7 and FIG. 8 show examples in each of which the at least one abutment portion 17K contacts a lower end of the movable pulley portion 9.

### Other Embodiments

The speed control mechanism 17 is not limited to the configurations shown in the above described embodiments. For example, the speed control mechanism 17 may be configured with a rotary viscous damper in place of the centrifugal brake mechanism. Alternatively, the speed control mechanism 17 may be configured with a friction damper in place of the viscous damper mechanism.

Although the cable retention mechanism 14 is provided in each of the above described embodiments, an example may be employed in which the cable retention mechanism 14 is not provided.

Although the winding mechanism 11 comprises the stationary pulley portion 7 and the movable pulley portion 9 in each of the above described embodiments, this is not limitative. For example, it may be possible to employ a configuration in which the charging cable 3 is wound by an electric motor.

What is claimed is:

1. A charging stand comprising:
a charging cable detachably attachable to an electrically-driven vehicle;
a winding mechanism configured to wind the charging cable and comprising a movable portion that operates in accordance with a movement of the charging cable;
a housing configured to house the winding mechanism; and
a speed control mechanism configured to operate when the charging cable is wound by the winding mechanism and to control an operation speed of the movable portion so as not to exceed a preset speed.

2. The charging stand according to claim 1, wherein the speed control mechanism comprises a viscous damper mechanism using a viscous fluid.

3. The charging stand according to claim 1, wherein the speed control mechanism comprises:
a centrifugal brake mechanism comprising:
a brake shoe configured to rotate in accordance with an operation of the movable portion and to be radially shiftable; and
a brake drum having an inner circumferential surface that is slidingly contactable with the brake shoe.

4. The charging stand according to claim 1, wherein the speed control mechanism comprises:
an abutment portion configured to contact the movable portion; and
an elastic body configured to exert on the movable portion an elastic force in a direction to inhibit the operation of the movable portion through the abutment portion.
